(19) United States
(12) Patent Application Publication
(10) Pub. No.: US 2012/0017776 A1
(43) Pub. Date: Jan. 26, 2012

(54) Easy-Flip revolving grid cooking apparatus.

(76) Inventor: George Geoffrey Banjavich, Winnipeg (CA)

(21) Appl. No.: 12/181,588

(22) Filed: Jul. 29, 2008

(30) Foreign Application Priority Data
Jul. 1, 2008 (CA) 26351976

(51) Int. Cl. A47J 43/18

(52) U.S. Cl. 99/426

(57) ABSTRACT

The cooking apparatus is a revolving stainless steel grid consisting of two equally fabricated stainless steel grates joined by a floating stainless steel hinge. The revolving cooking grid design allows for one to insert food items of varying sizes and densities into one half of the grid, and then the ability to close the second half of the grid on top of the inserted food items in the bottom grid, so as to prevent the items from falling out during transport to and from, or within the cooking oven itself.

This invention is a specialized cooking device which allows access of naturally occurring convection currents of heated air within a cooking oven to evenly and efficiently cook the surface area, all the way through to the interior, of food items placed within its confines.

Common cooking apparatuses tend to cook food unevenly as the surface where the item is placed becomes heated and acts as a secondary surface for cooking the food. This process is inefficient as the majority of the oven's internal heat is used to heat the secondary surface rather than the intended targets being the food items. It is also inefficient with regards to time, as well as energy, as the food items end up cooked on only one side rather than from all angles. In order to cook the opposing side of the food items, one must flip over each food item individually thus repeating the initial steps of the cooking process. This process can also have the undesired side effect of over cooking the food on one or both sides.

I have found that these disadvantages can be overcome by inserting the food items into a uniquely shaped stainless steel grate matrix which allows the oven's natural convection currents to evenly and efficiently cook the food from all angles. The food is cooked all the way through, without burning, as the minimized surface area makes it less likely for the food to be over cooked on any of its sides. This quick and efficient process allows for thorough cooking in no more than half the time of common cooking apparatuses.

In drawings which illustrate embodiments of the invention, DRAWING 0 is a three dimensional rear view where the two main sections of the device are indicated and labeled as the cooking grid hemispheres and the floating hinge that joins them, which are broken down in detail via DRAWING 1 and DRAWING 2 respectively. The two final images, PHOTOGRAPH 1 and PHOTOGRAPH 2, respectively show the invention in its pristine manufactured state and then put into practice in an example of its intended usage as a cooking device.

DRAWING 1, Illustration A, is a top view of the cooking grid itself. The entire unit is constructed of surgical grade stainless steel #304 (NiB). Figure I denotes the length of the object at 438 mm and Figure II denotes its width at 203 mm. The entire rim of each hemisphere is constructed from stainless steel wire with a diameter of 4.8 mm, as denoted by Figure IX. The front and rear straight edges of the outer rim of the object are 366 mm as denoted by Figure III. At that point, the outer rim bends 55 degrees, denoted in Figure XII, for a length of 55 mm, as denoted in Figure XIX. The rim is then bent back straight down for a length of 108 mm, shown in Figure XX, which forms the gripping handle edges of the unit. These handles have a gap that extends for 40 mm on either side of the unit, as denoted in Figure X, from the outer handle edge to the inner rim bars which are both 193.4 mm in length, as shown in Figure XVIII. These inner rim bars are welded to the outer rim, thus making the entire rim, handles and all, one solid rim.

DRAWING 1, Illustration A, Figure IV, shows where the actual grating itself begins, and continues for a length of 349 mm, and a width, as shown in Figure II, of 203 mm. This grating is constructed from 18 gauge surgical grade stainless steel wire #304 (NiB) with a diameter of 1.2 mm, as denoted in Figure VIII. The 203 mm lengths of wire (Figure II) and the 349 mm lengths of wire (Figure IV) are welded to the frame, from tip to tip, forming the grating surface which is comprised of equal 14 mm (Figure VI) by 14 mm (Figure VII) spacing.

DRAWING 1, Illustration B and Illustration C, Figures XIV & XV, show the 110 degree bend in the 18 guage wire that is made after the wire has traveled 6 mm (Illustration B, Figure XIII) from the welding point at the rim. The process is then repeated in the reverse when the wire reaches the other end of the rim where it is subsequently welded into place.

DRAWING 1, Illustration C, Figure XVII, denotes the lip depth from the rim to the lower grating surface. This lower grating surface, the actual cooking area itself, is 324.7 mm long (Illustration A, Figure V), by 171.9 mm wide (Illustration A, Figure XI).

DRAWING 1, Illustration D, shows a three dimensional view of what each cooking hemisphere looks like upon completion of construction.

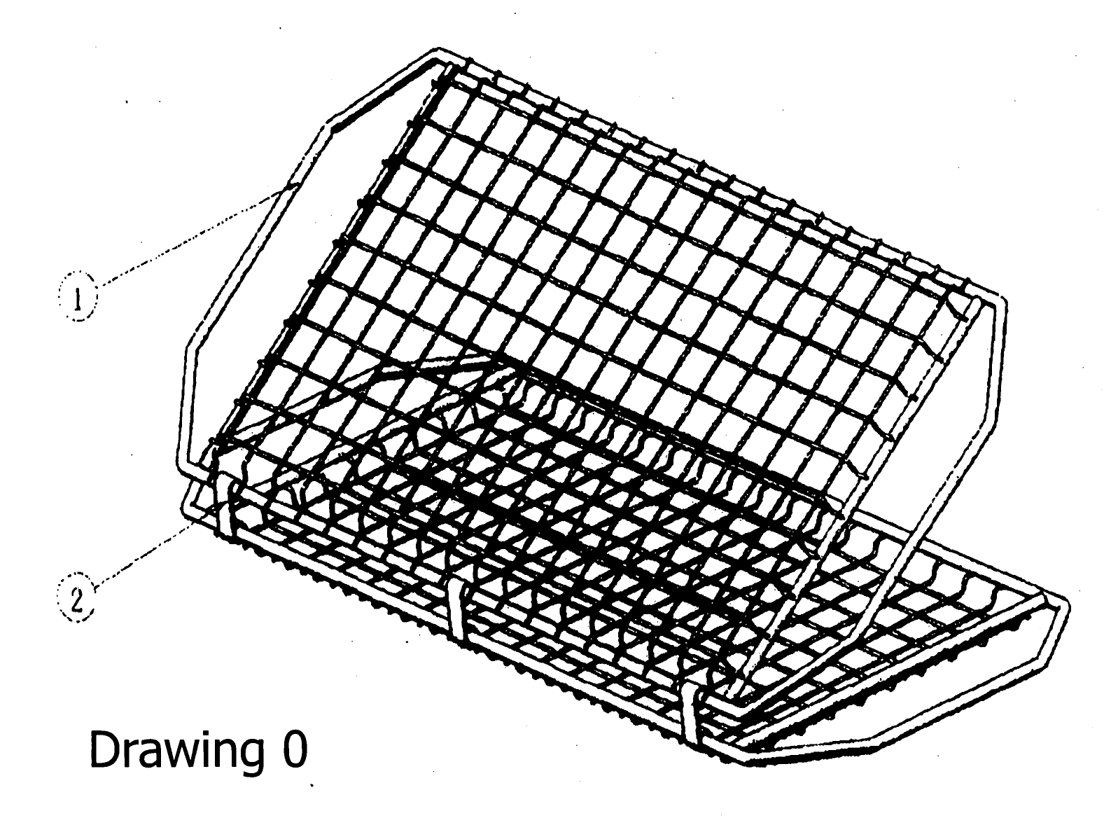

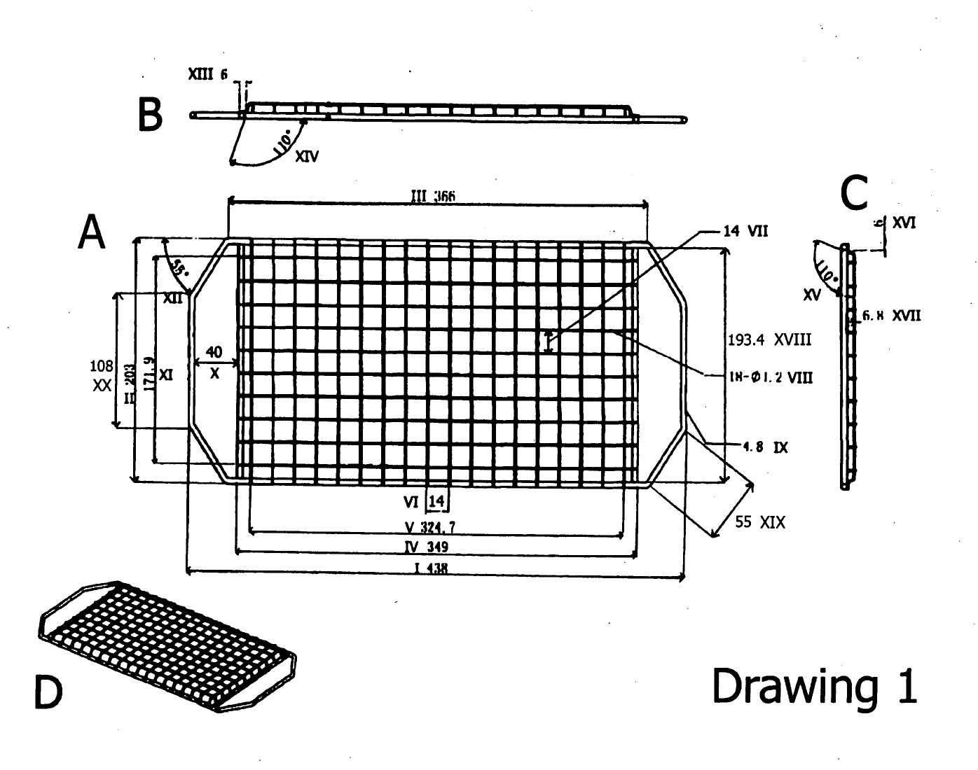

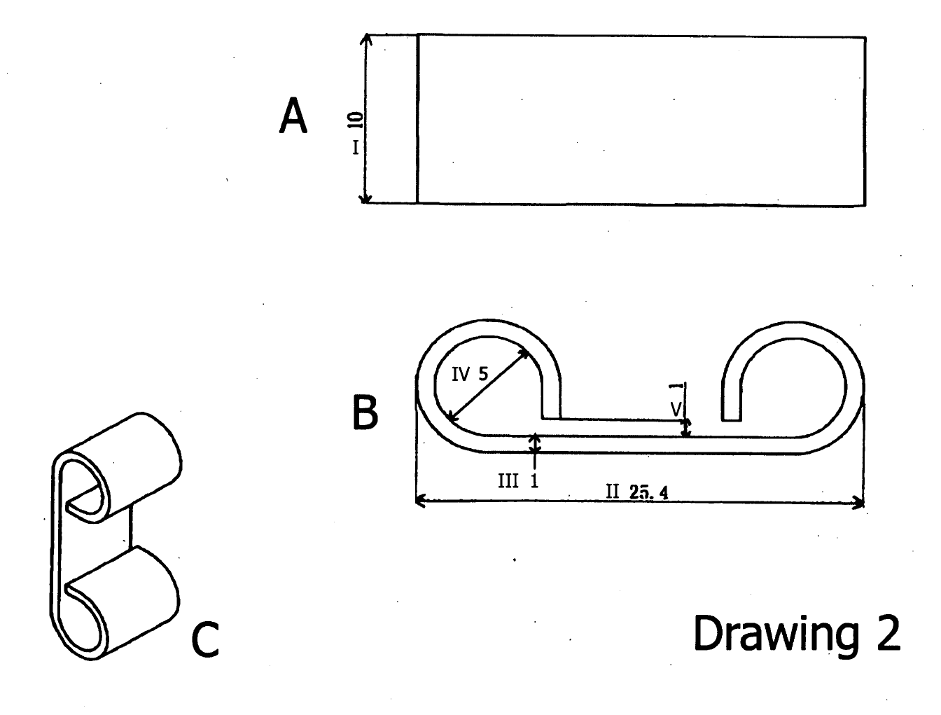

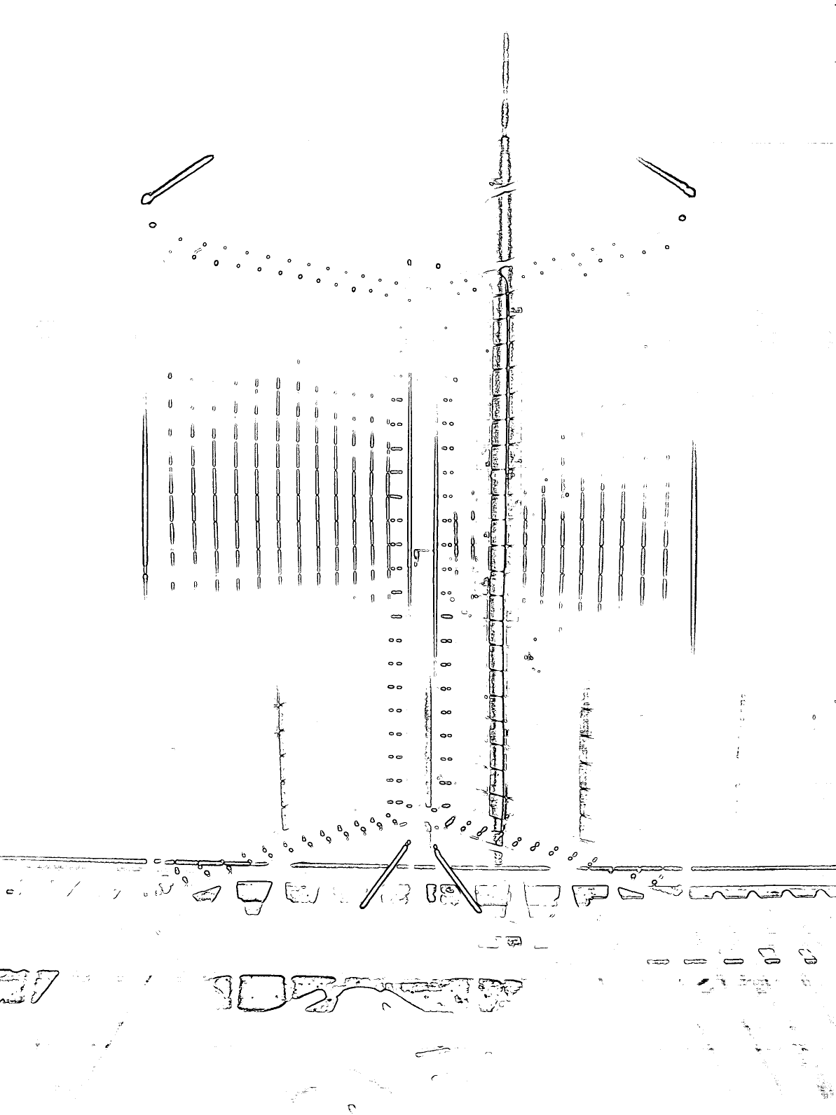

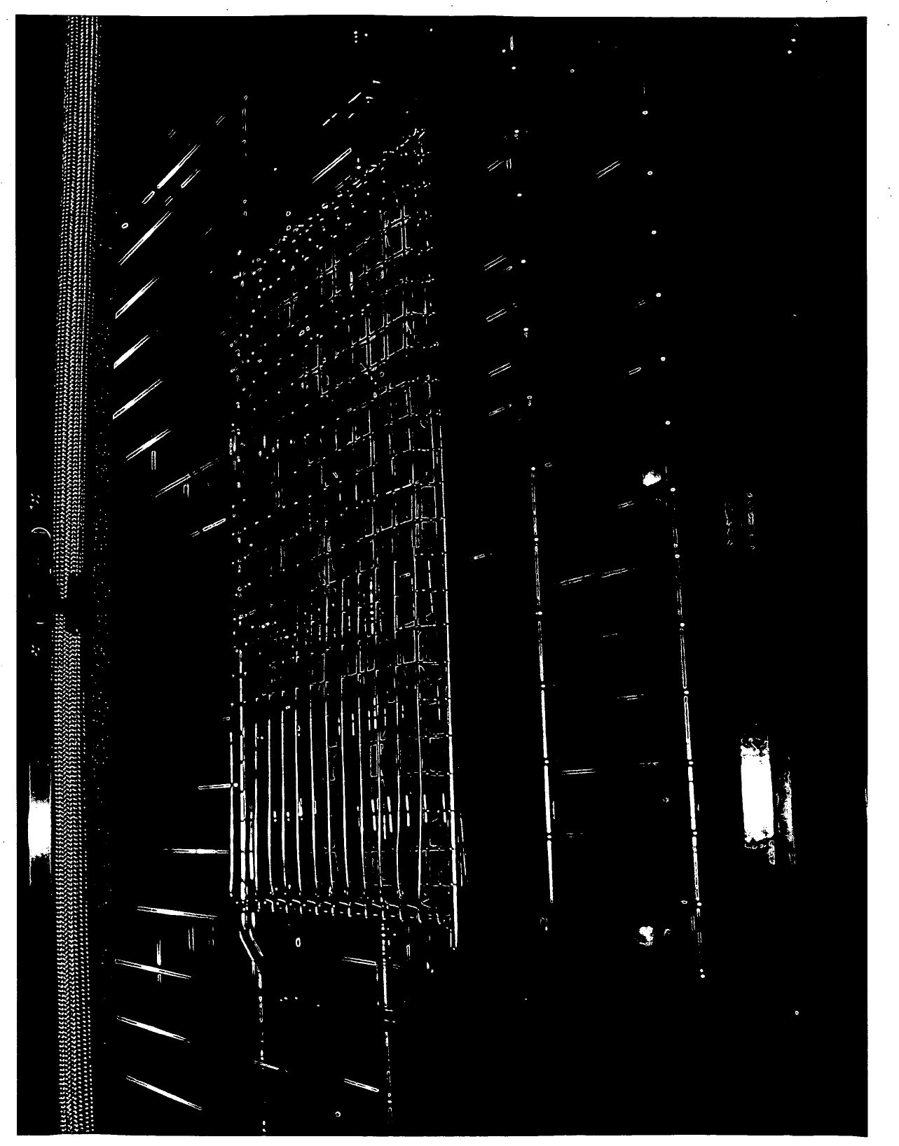

DRAWING 2, Illustration A, FIG. 1, shows the width of surgical grade stainless steel #304 (NiB) hinge at 10 MM. Illustration B, FIG. 2, shows its length at 25.4 mm, with a thickness of 1 mm (Figure III). Three hinges are then crimped around the outer leading edge. As seen in DRAWING 2, Illustration B, Figure IV, the diameter of each crimped end of the hinge is 5 mm, with an open gap spacing of 1 mm (Figure V), thus allowing ample room for free movement of the rim to revolve, as the rim's diameter is only 4.8 mm (DRAWING 1, Illustration A, Figure IX).

1. This unit is a cooking device made from two equal grated hemispheres of surgical grade stainless steel that are joined by a surgical grade stainless steel floating hinge.

2. As defined in claim 1, this unit has two halves which come together to form a cooking surface that is enclosed, allowing for various sizes and types of food to be placed within its confines.

3. As defined in claims 1 and 2, this enclosed cooking surface has specialized properties that allow it to perform a unique function, which is to cook the food via direct exposure to convection currents of heated air within a cooking oven without allowing the food to escape from the unit before, during, and after the cooking process, until which time it is so desired to remove solid food items.

4. As defined by claims 1, 2 and 3, this specialized unit makes use of its unique properties in order to cook food thoroughly and evenly through its minimized surface area, thus granting maximum efficiency of the cooking oven's heat to the food that is to be cooked.

5. As defined by claims 1, 2, 3 and 4, this unit's maximised efficiency allows food to be cooked in at least half the time of conventional cooking apparatuses that are used in cooking ovens for these types of applications.

6. As defined by claims 1, 2, 3, 4, and 5, this unit's minimized surface area and maximum efficiency allow it to cool down much more rapidly than conventional cooking apparatuses that are used in cooking ovens for these types of applications.
